(19) United States
(12) Patent Application Publication
(10) Pub. No.: US 2023/0262128 A1
(43) Pub. Date: Aug. 17, 2023

(54) INTELLIGENT ENVIRONMENTAL HEALTH DEVICE

(71) Applicant: Saudi Arabian Oil Company, Dhahran (SA)

(72) Inventors: Hassan M. Alzain, Dhahran (SA); Salim Khasawinah, Dhahran (SA); Karim Hussein, Dhahran (SA)

(21) Appl. No.: 17/651,184

(22) Filed: Feb. 15, 2022

(51) Int. Cl. H04L 67/12; G06F 8/65; G06N 20/10; G16Y 20/10; G16Y 40/10; G16Y 40/35

(52) U.S. Cl. CPC H04L 67/12; G06F 8/65; G06N 20/10; G16Y 20/10; G16Y 40/10; G16Y 40/35

(57) ABSTRACT

An apparatus for taking environmental health measurements comprises a portable that encloses an onboard processor, a transceiver coupled to the onboard processor, a camera coupled to the onboard processor; and a suite of sensors all coupled to the processor including an infrared temperature sensor, a probe thermometer, a sound sensor and at least one water content sensor. In addition, the apparatus includes a distance sensor and a display. The onboard processor is configured to launch an application for guiding a user for taking environmental and health parameter measurements from objects using at least one of the sensors enclosed in the housing and is further configured with code for determining whether measured parameters are within prescribed safety thresholds.

### FIELD OF THE DISCLOSURE

The present disclosure relates to environmental and health testing and more particularly relates to an intelligent environmental health device that is equipped and configured to collect and analyze on-the-fly full range of environmental and health data for compliance with pertinent environmental and health regulations and to guide the user regarding steps and procedures required to collect such data correctly. In additions, it helps in collecting enormous amount of raw data that can be used in the long-term to extract insights, hidden patterns, and future predictions using cloud computing services.

### BACKGROUND OF THE DISCLOSURE

The field of environmental health is concerned with the protection of the human health and home environment. A main focus of this field is the detection and analysis of chemical, physical and biological factors that pose potential health dangers in the home or office environment.

One of the sub-field of environmental health is food safety. Food can transmit hazardous pathogens, and lead illness. Without effective hazard analysis (e.g. chemical, physical and biological) and control of critical points, fungus, viruses, harmful bacteria and mold can grow in/on foods. Physical hazards are typically assessed by the environmental health officer by testing whether there is physical contamination (e.g. glass or plastic) in foods, whereas chemical contamination is typically assessed by ensuring that harmful chemical products are not present in food items. Biological hazards require more detailed detection and analysis and rely on temperature testing using infrared and probe thermometers to detect the presence of bacteria or other pathogens.

Water Safety is another important sub-field of environmental health. The water supply needs to be monitored to prevent the potential of spread of water-borne diseases such as respiratory disease, diarrhea, fever, Hepatitis E & A, paralysis, and Progressive Multifocal Leukoencephalopathy. Furthermore, regulators are concerned with the standard of environmental health in housing and other residential spaces. Poor construction materials and design can also lead to the growth and spread of communicable-diseases. Noise and other nuisances can also contribute toward adverse physiological effects such as sleep-deprivation & annoyance.

Generally, environmental health assessments are made by taking samples (e.g. food samples & water samples, detection of housing measurements & noise measurements) to ensure that the measurements are in compliance with pertinent regulations. However, to take a full range of measurements requires not only the necessary equipment but also expertise as to the precise way in which the measurements are prescribed to be carried out. Small inaccuracies in procedure can lead to inaccurate results and wasted time and resources.

### SUMMARY OF THE DISCLOSURE

In a first aspect, an apparatus for taking environmental health measurements is disclosed. An apparatus for taking environmental health measurements comprises a portable that encloses an onboard processor, a transceiver coupled to the onboard processor, a camera coupled to the onboard Application-Specific Instruction Set Processor; and a suite of sensors all coupled to the processor including an infrared temperature sensor, a probe thermometer, a sound sensor and at least one water content sensor. In addition, the apparatus includes a distance sensor and a display. The onboard processor is configured to launch an application that guides a user for via information presented on the display in taking environmental and health parameter measurements from objects using at least one of the sensors enclosed in the housing and is further configured with code for determining whether measured parameters are within prescribed safety thresholds.

In some embodiments, the onboard processor is configured by the code to recognize, through the camera an object to be measured, and to determine from a measurement received from the distance sensor and a type of the recognized object, whether the object is at a correct distance from the apparatus for a correct parameter measurement.

In preferred embodiments, the onboard processor is configured to receive data and instruction updates from a cloud-based machine learning system through the transceiver.

In a second aspect, the present disclose describes a method for guiding users to take an environmental health measurement from an object using a smart virtual assistant. The method comprises receiving a user selection for an environmental health measurement to be taken including a type of measurement and a type of instrument used for measuring the object, displaying and pronouncing a guide to the user for taking the measurement, receiving a measurement taken by selected instrument, determining whether the measurement is within the thresholds of pertinent environmental health regulations, and alerting the user as to an outcome of the determining step.

These and other aspects, features, and advantages can be appreciated from the following description of certain embodiments and the accompanying drawing figures and claims.

### BRIEF DESCRIPTION OF THE DRAWINGS

FIG. 1 is a schematic front view of an embodiment of an apparatus for taking environmental health measurements according to the present disclosure.

FIG. 2 is a schematic top view of an embodiment of an apparatus for taking environmental health measurements according to the present disclosure.

FIG. 3 is a schematic side view of the embodiment of the apparatus shown in FIGS. 1 and 2.

FIG. 4 is a schematic diagram of a cloud-based system for using machine learning to perform environmental and health measurements according to an embodiment of the present disclosure.

FIG. 5 is a flow chart of an exemplary method of guiding a user of the disclosed apparatus through a proper environmental health measurement.

### DETAILED DESCRIPTION OF CERTAIN EMBODIMENTS OF THE DISCLOSURE

The present disclosure describes an intelligent environmental health device (referred to herein as “the apparatus”) that is designed to enable a user of the apparatus to collect and analyze real-time field data related to the environment or health (or both) more accurately. The apparatus includes, among other elements, a number of different sensor components, a true-color display screen, a transceiver, a speaker, a microphone, and a processing component. The apparatus is capable of measuring and analyzing in real-time data in the fields of food safety, noise, water safety and housing. The apparatus is capable of connectivity to a cloud-based server at which data collected by the apparatus can be stored and more fully analyzed. The cloud-based server can provide feedback to the user of the apparatus in real time. Moreover, the apparatus is configured with a guide program or module that guides users (such as environmental health professionals) regarding the precise steps required to capture, assess, analyze and evaluate areas of interest in order to secure compliance with environmental health regulations.

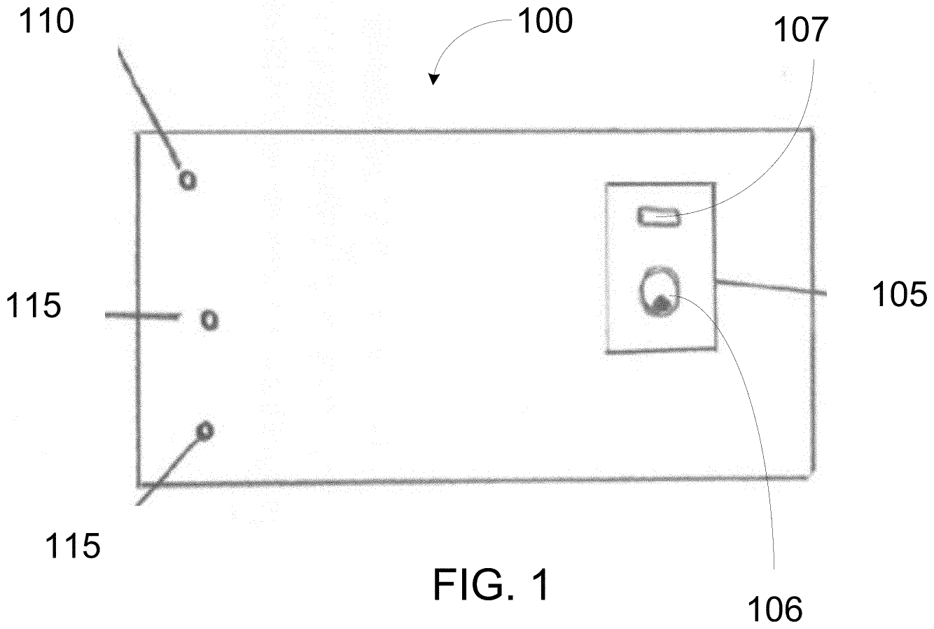

FIG. 1 is a schematic front view of an embodiment of an apparatus 100 for taking environmental health measurements according to the present disclosure. The apparatus includes an AI system component 105. The AI component 105 includes a camera 106, light source 107 (e.g., one or more LEDs) and an on-board processor (not shown in FIG. 1). The onboard processor is a specific purpose processor, an application specific integrated circuit (ASIC), one or more programmable logic controllers (PLCs), one or more field programmable gate arrays (FPGAs), a group of processing components, or other suitable processing components. The onboard processor can include or be coupled to a local memory unit which can be implemented using one or more devices (e.g., memory units, storage devices, etc.) for storing data and/or computer code for completing and/or facilitating the various processes described in the present disclosure. The AI component 105 also includes a receiver configured to receive signals from as the Global Positioning System (GPS) to detect and store outdoor coordinates. Through use of the GPS, the apparatus can obtain and record the outdoor position of the apparatus and objects in the vicinity of the apparatus, as for indoor positions the apparatus will use Wi-Fi connectivity to detect and store coordinates whenever available.

The apparatus 100 also includes a suite of sensors and detectors that can be employed by a user of the apparatus to acquire local environmental data (e.g., in a house, food items, local water supply). The suite of sensors includes an infrared thermometer 110. The infrared thermometer 110 is configured to receive black-body radiation emitted from objects and to infer temperature values from the received radiation. The infrared thermometer 110 can include a laser to ensure accuracy and flexibility in aiming the thermometer to receive infrared radiation from objects or certain part of objects. The infrared thermometer 110 can also include a lens to that concentrates the infrared thermal radiation onto a detector for the conversion of the incoming radiation to electrical signals. A sound sensor 115 (e.g., microphone) is included to receive sound measurements and, more particularly, to measure the overall magnitude of sound. Sound by the sound sensor 115 is comprehensively assessed in terms of a ‘Sound Level Meter’. The sound level meter readings can be displayed to the user in terms of decibels along with recommended sound exposure limits.

In addition, a laser distance sensor 120 is included. The laser distance sensor 120 of the apparatus consists of at least one laser transmitter can be directed toward an object by the user, one or more receiver sensors that include a light detector, a signal amplification assembly and a sampling circuit that measures the timing the transmission and reception precisely. The distance is calculated by either circuitry of the sensor or by the onboard processor based on the timing of the transmission of the laser pulses and the receipt of laser radiation reflected from the targeted object.

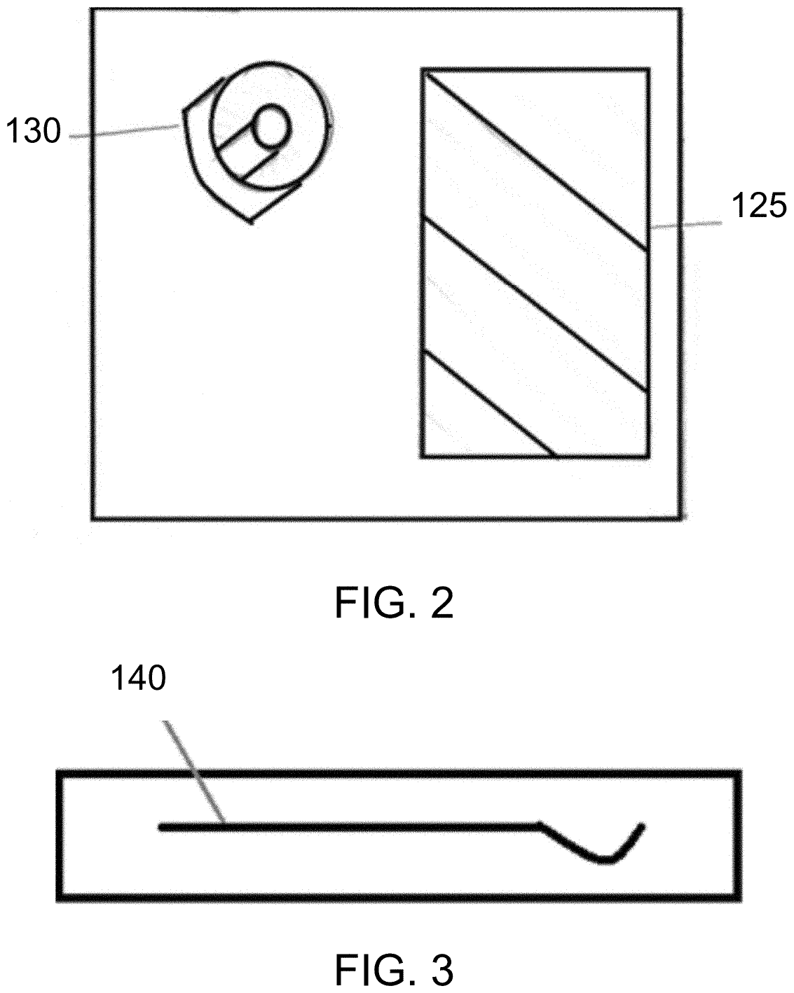

FIG. 2 is a schematic top view of the embodiment of the apparatus 100 shown in FIG. 1. The top side of the apparatus 100 further includes a display screen 125 such as an LCD monitor. The display screen also preferably functions as a touch screen user interface. However, in other embodiments, the apparatus can include a separate user interface. The display screen 125 receives processed data from the other components of the apparatus and displays the data to the user. The processor is configured to provide menu options for display of various environmental health regulations which are uploaded to the onboard memory periodically or access externally. The top side of the apparatus is also equipped with water sensor and analyzers 130. The water sensors and analyzers 130 can receive a sample of water (either drinking water or raw water) from a local environment and can assess the water in real time to produce analysis & measurements of essential water parameters such as, but not limited to: Total Dissolved Solids (TDS); free Chlorine; Redox Potential; pH; Nitrate levels (such as NO₃—N(N)); Turbidity (T); VOCs; and Electrical Conductivity (EC). To perform these measurements, the water sensors and analyzers comprise a suite of different types of detectors that includes but is not limited to a water quality sensor, a pH sensor, oxygen sensor, or a chemical sensor that detects a specific substance, chemical, or element, such as mercury, iron, or lead, etc.

In FIG. 3, which is a schematic side view of the embodiment of the apparatus 100 shown in FIGS. 1 and 2, an additional thermometer 140 is included. This thermometer differs from the infrared thermometer 110 in that it is a probe that is used to take temperature measurements via direct physical contact, rather than be receiving black body radiation. In one example, the probe thermometer 140 can comprise a pointed metal arm that can be inserted into objects, such as food items, to gathers information on the internal temperature of the object or specific parts thereof. The probe thermometer can include a dedicated digital read-out to display the measured temperature.

The on-board processor is configured to receive data from the various sensors and detector of the apparatus and to compare received data regarding environmental parameters against preset environmental health parameter thresholds. Before taking a measurement, the user can enter information via the display screen/user interface which can present a menu of options for taking measurements. For example, if the user wishes to measure ambient temperature in a location, a temperature measurement option can be selected from the menu. Thereafter, once the measurement is taken, the measurement can then be automatically compared with a preset temperature threshold.

The onboard processor is also configured to execute one or more artificial intelligence and/or machine learning algorithms referred to herein generally and collectively as an “AI program,” which comprise code that is included in but distinct from the AI component 105 of FIG. 1. The AI program takes as input images taken from the camera 106, the laser distance sensor 120 (possibly the sound sensor as well) and a GPS sensor and performs object and environment identification using the received information. As one illustrative example, if the user of the apparatus is in a home kitchen environment, and the images are distance measurements are acquired within this environment, the AI program can identify the kitchen environment from the shape of the objects and other layout information. Furthermore, the AI program can identify specific elements of the kitchen environment such as ovens, refrigerators, sinks, etc. This information can be recording in coordination with GPS information. Accordingly, when a measurement is taken at an object such as a refrigerator, the AI program can identify the target object as a refrigerator.

Data obtained from the laser distance sensor is used to assess whether the apparatus is at a correct distance to acquire an infrared temperature measurement. Feedback is provided to the user via an alert (visual and/or sound) if the current distance between the apparatus and the refrigerator is not within a target range. If a measurement is taken within the correct prescribed distance range, the AI program compares the measured temperature value with operational thresholds for the refrigerator. If a threshold has been exceeded, the AI program provides an alert and additional feedback. Moreover, the onboard algorithms can guide users regarding a prescribed order of taking specific measurements (if applicable) and can prevent (not allow) measurements being taken out of order. The guiding capability enables non-environmental health professionals to take measurements that would otherwise need to be performed by experienced professionals. The apparatus can also have a deep learning capability to recommend specific actions based on user behaviors, data accuracy, and measurement anomaly. This may include the recommendation of doing recalibration to one of the onboard sensors, restart the device, replace one of the deployed hardware pieces, update installed software program, and retry a measurement. This deep learning function will be ruing in the cloud server side benefiting from the stored historical time-series data for the same device/sensor/location/surveyor.

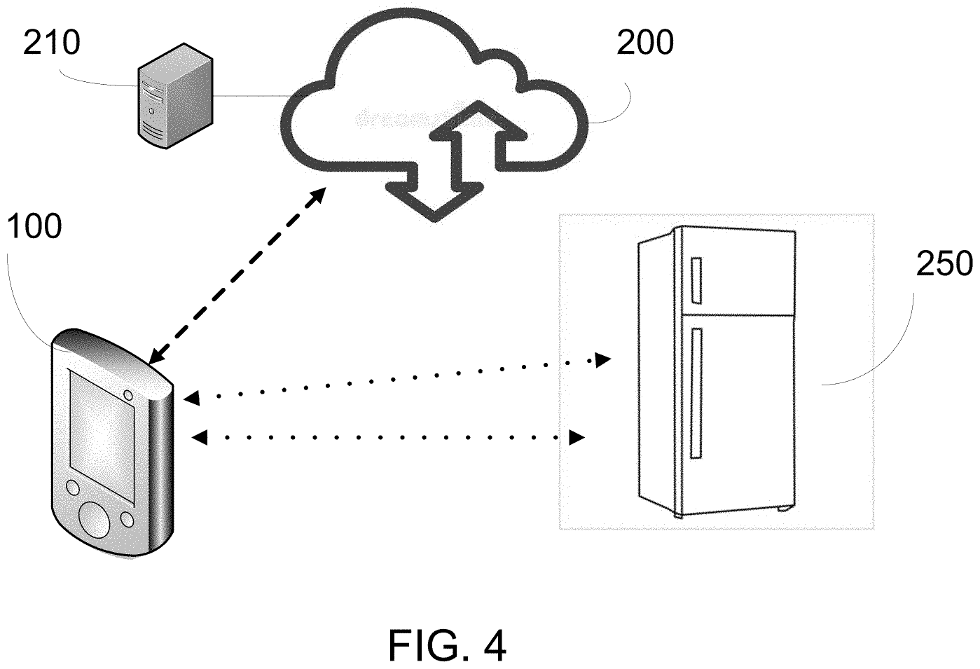

While the AI program can be used offline, the apparatus can be connected to a cloud-based server to enable machine learning. FIG. 4 is a schematic diagram of a system for using machine learning to perform environmental and health measurements according to an embodiment of the present disclosure. The apparatus 100 connects via wireless communication to a cloud-based server 210 over the Internet 200. The term “cloud” as used herein means computing resources, including servers, that are accessed over the Internet, and the software and databases that run on those servers. The apparatus 100 also acquires visual, sound and measurement data from an object 250 using the sensor described above and can transmit that data to the server 210. Communication between the apparatus 100 and the cloud server can be via a cellular network, using the family of protocols known as Wi-Fi or IEEE 802.11, the family of protocols known as Bluetooth, or another protocol. The network can comprise a wireless mesh network (e.g., Bluetooth mesh).

The cloud-based server AI program can be configured both to store data regarding measurements received from various apparatuses used in the network, and to execute AI/machine learning algorithms to “learn” from the data to improve recognition, supervised classification, unsupervised classifications and measurement trends in the short and long terms. The AI/machine learning algorithms can comprise one of a number of unsupervised and supervised AI and machine learning algorithms and programs such as but not limited to, Bayesian, k-Nearest Neighbor (kNN), Support Vector Machines (SVM), and deep learning networks such as convolutional neural networks (CNNs), recurrent neural networks (RNNs), Long Short-Term Memory Networks (LSTMs), natural language processing, and boosting algorithms.

Execution of the algorithms using a large data set gathered from a number of different sources of time enables incremental improvements in the accuracy and efficiency of measurements made of environmental health data. In particular, the trained algorithms provide feedback on data trends, best data measurement practices, and optimization of measurement parameters such as duration of measurement and distances. In addition, the trained algorithms automatically correlate across multiple facilities. As an example, as measurements of water content parameters are measured across various locations in a given region, the algorithms can determine measurements that vary a high magnitude (e.g., one or more standard deviations) from the mean of such measurements, indicating a potentially faulty. Moreover, by similar methods, one or more AI/machine learning algorithms can detect an apparatus that is either malfunctioning or is being used incorrectly.

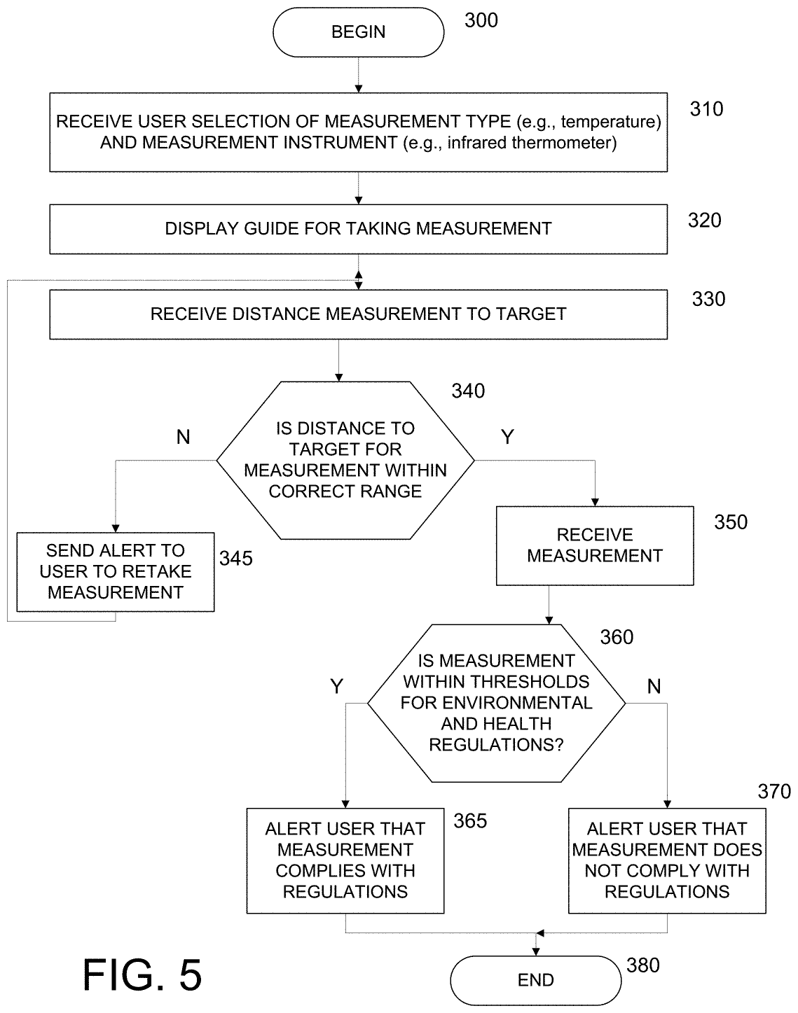

FIG. 5 is a flow chart of an exemplary method of guiding a user of the disclosed apparatus through a proper environmental health measurement. In step 300, the method begins. In step 310, the AI program receives user selections for an environmental health measurement to be taken including the type of measurement (e.g., temperature) and the type of instrument used (e.g., infrared thermometer) for an object to be tested. In step 320, the AI program displays a guide for taking the measurement to the user on the display screen 125 of the apparatus. In the following step 330, the AI program receives a distance measured from the apparatus to the tested object. In step 340, the AI program determines whether the distance measured is within the correct range. If it is determined that the distance is not in the correct range, in step 345, the AI program sends an alert to the user, for example on this display, and via sound, or by both a display and sound. After step 345, the process cycles back to step 330 as the user can moves toward or away from object, as necessary. In step 350, the AI program receives the measurement taken by the selected instrument of the apparatus. Upon receipt of the measurement, the AI program determines, in step 360, whether the measurement is within the thresholds of the pertinent environmental health regulations. In either case, the user is alerted as to the outcome (“in compliance”, step 365; “not in compliance”, step 370). The method ends in step 380.

The apparatus disclosed herein is portable and comprehensive in that it includes all or a majority of the tools and elements which an environmental health officer or an environmental scientist would require to effectively implement environmental health regulations and standards. The apparatus is mobile and can be easily carried from one location to another. Importantly, the AI program recognizes environmental settings, enabling proper guidance to be provided to the user for taking measurements. In addition, the apparatus provides real-time data evaluation with the ability to upload data and download updates from a cloud-based system.

It is to be understood that any structural and functional details disclosed herein are not to be interpreted as limiting the systems and methods, but rather are provided as a representative embodiment and/or arrangement for teaching one skilled in the art one or more ways to implement the methods.

It is to be further understood that like numerals in the drawings represent like elements through the several figures, and that not all components or steps described and illustrated with reference to the figures are required for all embodiments or arrangements.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and “comprising”, when used in this specification, specify the presence of stated features, integers, steps, operations, elements, or components, but do not preclude the presence or addition of one or more other features, integers, steps, operations, elements, components, or groups thereof.

Terms of orientation are used herein merely for purposes of convention and referencing and are not to be construed as limiting. However, it is recognized these terms could be used with reference to a viewer. Accordingly, no limitations are implied or to be inferred.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

What is claimed is:

1. An apparatus for taking an environmental health measurement, comprising:
a housing configured for manual use and portability, the housing enclosing:
an onboard processor;
a transceiver coupled to the onboard processor;
a camera coupled to the onboard processor;
an infrared temperature sensor coupled to the onboard processor;
a probe thermometer coupled to the onboard processor;
a sound sensor coupled to the onboard processor;
at least one water content sensor coupled to the onboard processor;
a distance sensor coupled to the onboard processor; and
a display coupled to the onboard processor.
wherein the onboard processor is configured with executable code for launching an application that guides a user via information presented on the display in taking environmental and health parameter measurements from objects using at least one of the sensors enclosed in the housing, the onboard processor being further configured with code for determining whether measured parameters are within prescribed safety thresholds.

2. The apparatus of claim 1, wherein the onboard processor is configured by the code to recognize, through the camera an object to be measured, and to determine from a measurement received from the distance sensor and a type of the recognized object, whether the object is at a correct distance from the apparatus for a correct parameter measurement.

3. The apparatus of claim 1, wherein the onboard processor is configured to send alerts to the user if it is determined that the measured parameters on not within the prescribed safety thresholds.

4. The apparatus of claim 2, wherein the onboard processor is configured to receive data and instruction updates from a cloud-based machine learning system through the transceiver.

5. The apparatus of claim 4, wherein the onboard processor is configured with a corresponding AI/machine learning program that is used to recognize the type of the object being measured.

6. The apparatus of claim 5, wherein the AI/machine learning program includes one or more of Bayesian, k-Nearest Neighbor (kNN), Support Vector Machines (SVM), convolutional neural networks (CNNs), recurrent neural networks (RNNs), Long Short-Term Memory Networks (LSTMs), natural language processing (NLP), and boosting algorithms.

7. The apparatus of claim 1, wherein the at least one water content sensor detects magnitudes of at least one of total dissolved solids (TDS), free Chlorine, Redox Potential; pH, Nitrate level, turbidity (T), and electrical conductivity (EC).

8. A method for guiding users to take an environmental health measurement from an object comprising:
receiving a user selection for an environmental health measurement to be taken including a type of measurement and a type of instrument used for measuring the object;
displaying a guide to the user for taking the measurement
receiving a measurement taken by selected instrument;
determining whether the measurement is within the thresholds of pertinent environmental health regulations; and
alerting the user as to an outcome of the determining step.

9. The method of claim 8, further comprising:
before receiving the measurement, receiving a distance measured from the apparatus to the tested object;
determining whether the distance measured is not in a correct range for the instrument and object; and
sending an alert to the user to change the distance if it is determined that the distance measured is not in the correct range.

10. The method of claim 8, wherein the type of instrument includes comprises one of an infrared thermometer, a probe thermometer, a water content sensor, and a sound sensor.

11. The method of claim 8, wherein the step of displaying the guide further comprises announcing the guide to the user.
